(19) United States
(12) Patent Application Publication
(10) Pub. No.: US 2004/0062287 A1
(43) Pub. Date: Apr. 1, 2004

(54) Electric resistance furnace

(75) Inventor: Masahiro Moriwaki, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SHINAGAWA REFRACTORIES CO., LTD., Tokyo (JP)

(21) Appl. No.: 10/673,493

(22) Filed: Sep. 30, 2003

(30) Foreign Application Priority Data
Sep. 30, 2002 (JP) 2002-286465

(51) Int. Cl. H05B 3/00

(52) U.S. Cl. 373/109

(57) ABSTRACT

The invention provides an electric resistance furnace comprising an axially vertical, hollow center heating element, a center furnace body that comprises a heat-insulating member and is provided for supporting the center heating element, and a preheating means that is provided at a gap from the surface of the center furnace body and comprises a preheating element provided on the inner wall surface of a cylindrical heat-insulating member. A heat-insulating member is located at an upper surface and a lower surface of an outer heat-insulating member located around the preheating member and only on a center axis side of the furnace with respect to the area of projection of the preheating means.

### BACKGROUND OF THE INVENTION

The present invention relates generally to an electric furnace using a resistance heating element, and more particularly to a high-temperature electric resistance furnace that can be used even in an oxidizing atmosphere.

Among various types of electric furnaces known so far in the art, an electric resistance furnace using a resistance heating element has the features of being easy to handle and enabling in-furnace atmospheres to be easily set.

Especially for heating elements for electric resistance furnaces that can be heated to high temperatures in an oxidizing atmosphere such as one demanded for heat resistance testing where substances are heated to high temperatures, zirconia-based heating elements and lanthanum chromite-based heating elements are typically known. Among these, zirconia has the feature of being heated to temperatures of 700° C. to as high as 2,200° C.

Zirconia has a negative temperature coefficient of electric conductivity, and high electric resistance at low temperatures. For practical use of a zirconia-based heating element, it is inevitable to rely on preheating means for preheating the ziroconia-based heating element to a predetermined temperature.

On the other hand, once the zirconia-based heating element has worked to allow the electric resistance furnace to reach high temperature, such preheating means becomes no longer necessary. Instead, it is necessary to ensure means for disposal of radiant heat from the zirconia-based heating element and stable supply of electric current even to the zirconia-based heating element heated to high temperatures.

In particular, there is still a growing demand for an electric resistance furnace that can be quickly heated from room temperature to a temperature of about 2,000° C. at which a zirconia-based heating element works and used over and over without any premature break upon repetition of heating/cooling cycles.

For instance, JP(A)07161454 and JP(A)09245941 disclose an electric resistance furnace using a hollow zirconia-based heating element as the zirconia-based heating element.

Such an electric resistance furnace is featured by the formation of a high-temperature heating space, because the hollow heating element includes a heating space therein. However, when high temperature is reached, preheating furnace components inclusive of a preheating resistor are exposed to that high temperature and thermally damaged, often ending up with premature deterioration. For this reason, the components including a preheating resistor must be built up of material that is especially excellent in heat resistance with additional provision of water-cooling or other cooling means.

A primary object of the present invention is thus to provide an electric resistance furnace using a heating element having a high heat-endurance temperature such as a zirconia-based heating element, which enables heating and cooling to be quickly carried out and is of durability good enough to be used repetitively over and over.

### BRIEF DESCRIPTION OF THE DRAWINGS

FIG. 1 is illustrative in longitudinal section of one embodiment of the electric resistance furnace according to the invention.

FIG. 2 is illustrative of the appearance of one embodiment of the electric resistance furnace according to the invention.

FIG. 3 is illustrative in longitudinal section of another embodiment of the electric resistance furnace according to the invention.

FIG. 4 is illustrative of one embodiment of the ziroconia-based heating element.

FIGS. 5(A) and 5(B) are illustrative of another embodiment of the zirconia-based heating element according to the invention.

FIGS. 6(A) and 6(B) are illustrative of Examples 1 and 2 of the electric resistance furnace according to the invention.

FIGS. 7(A) and 7(B) are illustrative of Comparative Examples 1 and 2 for the electric resistance furnace of the invention.

FIGS. 8(A) and 8(B) are illustrative of Comparative Examples 1 and 2 for the electric resistance furnace of the invention.

### SUMMARY OF THE INVENTION

The present invention provides an electric resistance furnace comprising an axially vertical, hollow center heating element, a center furnace body that comprises a heat-insulating member and is provided for supporting said center heating element, and a preheating means that is provided with a gap from the surface of said center furnace body and comprises a preheating element provided on the inner wall surface of a cylindrical heat-insulating member, wherein:

a heat-insulating member is located at an upper surface and a lower surface of an outer heat-insulating member located around said preheating means and only on a center axis side of the furnace with respect to an area of projection of said preheating means.

Thus, in the electric resistance furnace of the invention, the gap is located between the center furnace body comprising a center heating element having high heat-endurance temperature and the preheating means located therearound, and the heat-insulating member provided on the upper and lower heat-insulating members of the electric resistance furnace is not positioned on the outside with respect to the area of vertical projection of the preheating means. This makes the dissipation of heat out of the electric resistance furnace so satisfactory that thermal adverse influences on the preheating means can be reduced to impart good durability to the electric resistance furnace.

According to the present invention, the center furnace body comprises a cylindrical, center heating element with electrically conductive connection terminal portions provided at two axial ends and a cylindrical insulator that surrounds the center heating element.

According to the present invention, the center furnace body comprises a center heating element wherein electrically conductive connection terminal portions are formed on a wall surface of a cylindrical member in a direction at right angles with its axis, and a holder member provided on an upper portion and a lower portion thereof, an outside diameter of which is given by a maximum diameter of the terminal portions of the center heating element.

According to the present invention, the center furnace body is a zirconia-based heating element.

### DESCRIPTION OF THE PREFERRED EMBODIMENT

According to the present invention, a heating element having high heat-endurance temperature such as a zirconia-based heating element is used as the center heating element. Around the zirconia-based heating element, a zirconia-based heat-insulating member is located with a gap from it, and a heating element for the preheating means is provided on the inner surface of a cylindrical heat-insulating member spaced away from the zirconia-based heat-insulating member. In addition, some contrivances are provided to the location of the heat-insulating members around the electric resistance furnace. It is thus possible to prevent damage to the zirconia-based heating element and breaks in electrically conductive members of platinum used as current-carrying means, make the zirconia-based heating element less susceptible to crack, and avoid breaks in the heating element for preheating means. In addition, it is possible to use a heating element formed of an alloy having a relatively low heat-endurance temperature as the heating element for the preheating means. These findings underlie the present invention.

The present invention is now explained specifically with reference to the accompanying drawings.

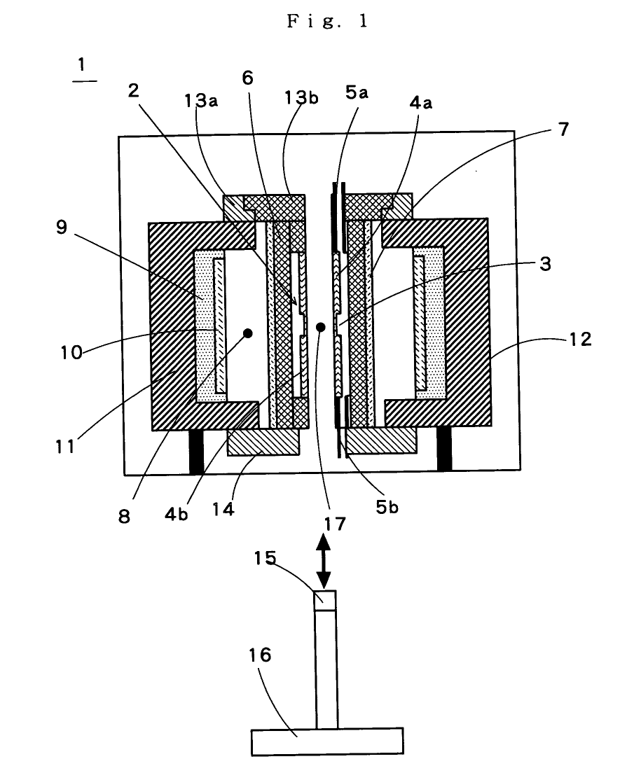

FIG. 1 is illustrative in longitudinal section of one embodiment of the electric resistance furnace according to the invention.

An electric resistance furnace 1 comprises a hollow zirconia-based heating element 2. At the center of the zirconia-based heating element 2, there is provided a heating element portion 3 having a small sectional area and provided at both its ends with terminal portions 4a and 4b each having a larger diameter. The terminal portions 4a and 4b are connected to a heating power source circuit via current-carrying platinum or other leads 5a and 5b.

Spaced away from the zirconia-based heating element 2, there is concentrically provided a zirconia-based insulating member 6, around which there is provided a cylindrical alumina-based insulating member 7. By the provision of the cylindrical alumina-based insulating member 7, it is not necessary to design the zirconia-based insulating member 6 in the form of a continuous member; the zirconia-based insulating member 6 could be divided at both its ends, its center or other sites into a plurality of portions. Hence, only the zirconia-based insulating member portion allocated to a high-temperature region where it suffers from severe damage can be replaced with a fresh one.

A cylindrical insulating member 9 is located with a gap 8 between it and the alumina-based insulating member and a preheating element 10 comprising a heat-resistant alloy or the like is located on the inside surface of the cylindrical insulting member 9, thereby providing preheating means. Further, an outer heat-insulating member 11 is provided to cover the peripheral, upper and lower surfaces of these parts.

The outer heat-insulating member 11 could be formed of any desired material provided that it has high heat resistance; however, alumina silica-based fibers should preferably be used. The outer heat-insulating member is provided on its outside with an outermost metal skin 12.

Upper heat-insulating members 13a and 13b are provided at sites of the upper surface of the electric resistance furnace 1, which are found on the center axis side of the furnace 1 with respect to the area of projection of the preheating element 10. Likewise, a lower heat-insulating member 14 is provided at a site of the bottom surface of the electric resistance furnace 1, which is found on the center axis side with respect to the area of projection of the preheating element 10.

At the lower portion of the electric resistance furnace 1, there is provided an elevator means 16 for introducing the sample 15 to be heated in a cylindrical internal space in the zirconia-based heating element, so that the sample 15 can be admitted into a heating space 17 heated to high temperature.

Upon startup of the electric resistance furnace 1 of the invention, electric current is passed through the preheating element 10 to make the electric conductivity of the zirconia-based heating element high enough for the full passage of electric current, following which the passage of electric current through the preheating element 10 is switched over to the passage of electric current through the zirconia-based heating element 2 so that the heating space can be brought by the passage of electric current through the zirconia-based heating element up to a predetermined temperature.

Once the zirconia-based heating element has reached the high temperature after completion of preheating, the electric resistance furnace essentially requires cooling and removal of heat for the purpose of preventing the constituting members of the electric resistance furnace inclusive of the preheating element from exposure to high temperature and degradations. For a conventional electric resistance furnace, means such as water cooling and air cooling have been used.

In the electric resistance furnace 1 of the invention, however, the upper heat-insulating members 13a, 13b and the lower heat-insulating piece 14 are not located outside of the area of projection of the preheating element 10, so that even when the zirconia-based heating element is heated to high temperature by the passage of current, dissipation of heat out of the heating element can occur properly, with the result that the preheating element can be prevented from exposure to too high a temperature. Thus, the preheating element formed of platinum wires, silicon carbide wires, molybdenum disulfide wires, lanthanum chromite wires or ferrite-based resistance alloy wires such as Kanthal wires can be well used, and so it is unnecessary to use any cooling means using water or other heat medium with the electric resistance furnace. If a member such as a so-called punching metal member is used for the outermost metal skin 12 provided on the outside of the outer heat-insulating member 11, it is possible to provide satisfactory dissipation of heat from the outer heat-insulating member 11. Only one requirement for the outer heat-insulating member 11 is that the zirconia-based heating element can reach the predetermined temperature by the generation of heat out of the preheating element 10.

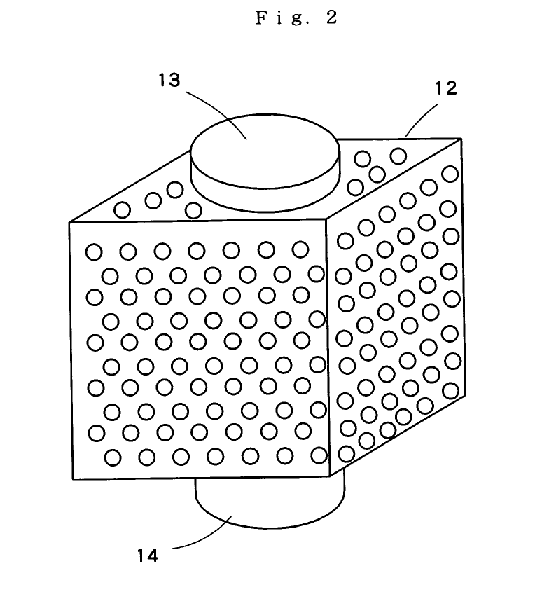

FIG. 2 is illustrative of the appearance of one embodiment of the electric resistance furnace according to the invention.

An electric resistance furnace 1 is covered with an outer metal skin 12 comprising a punching metal, and at sites of the upper and lower surfaces thereof, which are defined by only the area of projection of a preheating element, there are located an upper heat-insulating member 13 and a lower heat-insulating member 14.

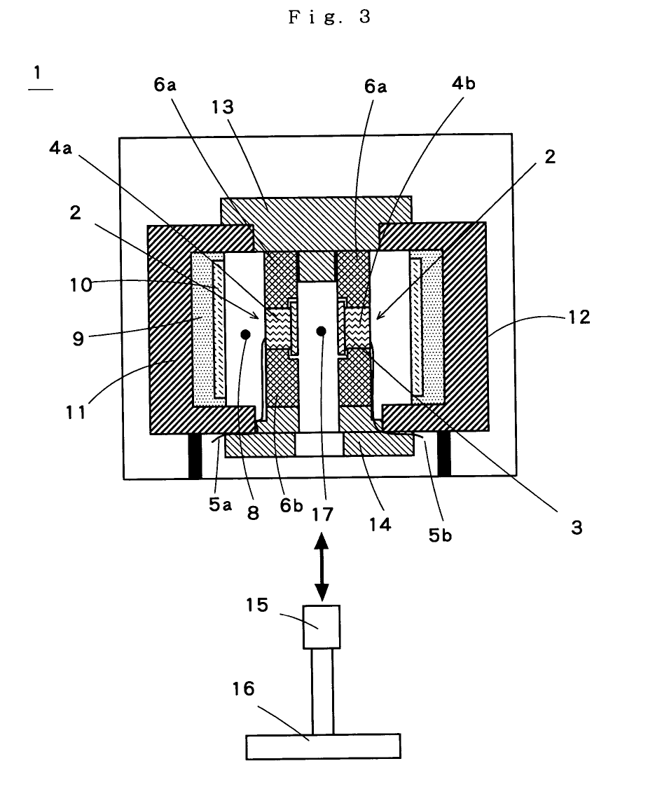

FIG. 3 is illustrative in longitudinal section of another embodiment of the electric resistance furnace according to the invention.

An electric resistance furnace 1 is built up of a flat form of cylindrical zirconia-based heating element 2 comprising a hollow zirconia-based refractory. The zirconia-based heating element 2 comprises a heating element portion 3 at the center and columnar terminal portions 4a and 4b leading to the cylindrical heating element portion, and the terminal portions 4a and 4b are connected to a heating power source via platinum or other current-carrying leads 5a and 5b.

At the upper and lower positions of the zirconia-based heating element 2, zirconia-based refractory materials 6a and 6b are located. A cylindrical heat-insulating member 8 is located away from and concentrically with respect to the zirconia-based heating element 2. A preheating element 10 comprising a heat-resistant alloy is located the inside surface of the cylindrical refractory. The heat-insulating member could be in a spiral, rod or sheet form. These members are entirely enclosed in an outer heat-insulating member 11.

In the electric resistance furnace shown in FIG. 3, the hollow zirconia-based heating element is provided on the outer surface of its cylindrical member with the terminal portions 4a and 4b each in a columnar form, and so heat generated out of the heating element portion 3 of the zirconia-based heating element is cut off by the terminal portions 4a and 4b. In other words, only a gap is required between the zironcia-based heating element and the preheating element 10; it is not necessary to provide any heat-insulating material or the like around these members.

An upper heat-insulating member 13 is provided at a site of the upper surface of the electric resistance furnace 1, which is found on the center axis side of the furnace 1 with respect to an area of projection of the preheating element 10. Likewise, a lower heat-insulating member 14 is provided at a site of the bottom surface of the electric resistance furnace 1, which is found on the center axis side with respect to the area of projection of the preheating element 10.

At the lower portion of the electric resistance furnace 1, there is provided an elevator means 16 for introducing the sample 15 to be heated in a cylindrical internal space in the zirconia-based heating element, so that the sample 15 can be admitted into a heating space 17 heated to high temperature.

Upon startup of the electric resistance furnace 1 of the invention, electric current is passed through the preheating element 10 to make the electric conductivity of the zirconia-based heating element high enough for the full passage of electric current, following which the passage of electric current through the preheating element 10 is switched over to the passage of electric current through the zirconia-based heating element 2 so that the heating space can be brought by the passage of electric current through the zirconia-based heating element up to a predetermined temperature.

In the electric resistance furnace 1 of the invention, the upper heat-insulating member 13 and the lower heat-insulating piece 14 are not located outside of the area of projection of the preheating element 10, so that even when the zirconia-based heating element is heated to high temperature by the passage of current, dissipation of heat out of the electric resistance furnace can occur properly, with the result that the increase in the temperature of the preheating element is less large. Thus, the preheating element formed of commonly available ferrite-based resistance alloy such as Kanthal wires can be well used, and so it is unnecessary to use any cooling means using water or other heat medium with the electric resistance furnace.

According to the present invention, a gap of preferably 10 mm to 100 mm and more preferably 20 mm to 60 mm should be provided between the zirconia-based heating element and the preheating element.

A gap of less than 10 mm is not preferred because of increased radiation heat to the preheating element. A gap of greater than 100 mm is again not preferred because of a drop of the efficiency of heating by the preheating element.

When, as shown in FIG. 1, the heat-insulating member is interposed between the zirconia-based heating element and the preheating element, the gap means that between the heat-insulating member and the preheating element.

It is preferable that the upper heat-insulating members 13a, 13b and the lower heat-insulating member 14 are 0.5 to 3 times as thick as the outer heat-insulating member located at the upper and lower surfaces of the electric resistance furnace. Too small a thickness is not preferable because much more heat is dissipated out of the zirconia-based heating element.

The zirconia-based heating element used with the electric resistance furnace of the invention is now explained.

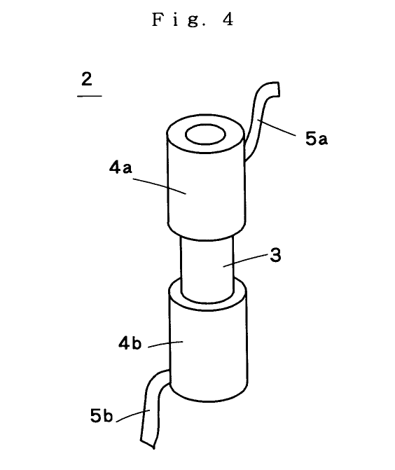

FIG. 4 is illustrative of one embodiment of the zirconia-based heating element.

A zirconia-based heating element 2 shown in FIG. 4 is made up of a heating element portion 3 having a constant inside diameter and a smaller outside diameter at its center, with terminal portions 4a and 4b of large sectional area being provided at both its ends. The terminal portions 4a and 4b are embedded therein with current-carrying leads 5a and 5b, respectively. As the preheating means operates to increase the temperature of zirconia thereby increasing the electric conductivity of zirconia, electric current can pass through zirconia so that an internal heating space can develop through heat generated out of the central heating element portion 3 having a small sectional area.

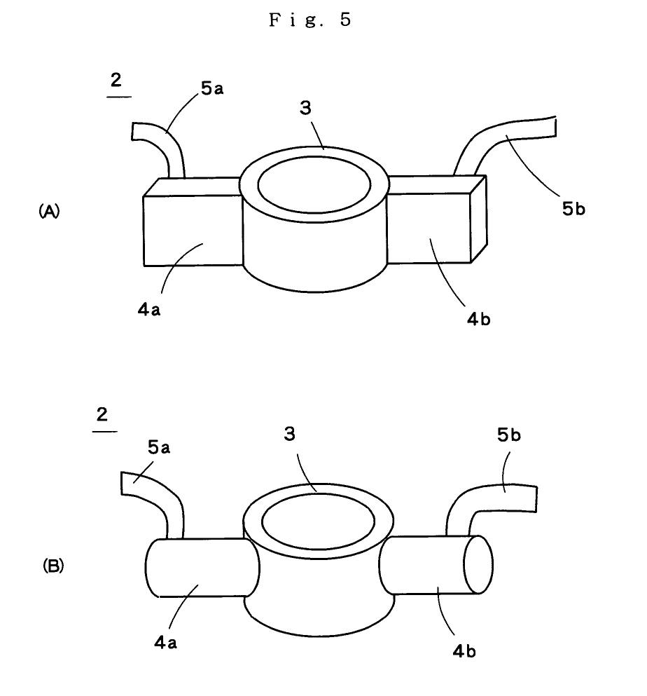

FIGS. 5(A) and 5(B) are illustrative of another embodiment of the zirconia-based heating element according to the invention.

A zirconia-based heating element 2 shown in FIG. 5(A) comprises a hollow, flat cylindrical zirconia-based heating element portion 3 provided on its outer surface with axially vertical, cuboidal terminal portions 4a and 4b. The terminal portions 4a and 4b are embedded therein and connected with current-carrying leads 5a and 5b such as platinum leads, respectively, and then with a heating power source.

A zirconia-based heating element 2 shown in FIG. 5(B) comprises a hollow, flat cylindrical zirconia-based heating element portion 3 that is provided on its outer surface with columnar terminal portions 4a and 4b. Both terminal portions are embedded therein with current-carrying leads 5a and 5b, respectively.

In the zirconia-based heating elements configured as shown in FIGS. 5(A) and 5(B), the terminal portions extend from the cylindrical surface in an axially vertical direction, so that when built in an electric resistance furnace, it is spaced largely away therefrom at the terminal portions and so the amount of a heat-insulating material interposed between it and a preheating means can be reduced or any heat-insulating material can be dispensed with.

The zirconia-based heating element used herein could be prepared using stabilized zirconia to which yttria, calcia, magnesia or the like is added as a stabilizer. For the stabilized zircona, it is preferable to use yttria-stabilized zirconia wherein the stabilizer is added in an amount of 5 to 20% by mass relative to the stabilized zirconia.

Although fired zirconia powders may be used for zirconia, it is preferable to make use of a mixture of zirconia powders with zirconia fibers because of increased strength with respect to thermal stress. The zirconia fibers used should preferably have a diameter of 0.1 μm to 20 μm and a length of 0.1 mm to 50 mm, and the zirconia powders should preferably have a particle diameter of 0.1 μm to 1,000 μm.

A mixture of zirconia powders with yttria-zirconia fibers, bonded together by methyl cellulose or other binder, may be molded or otherwise formed, and fired. In addition to the zircoia powders and zirconia fibers, a zirconia sol, an aqueous solution of zirconia salt or the like may be added.

Platinum leads or platinum-rhodium alloy leads used as current-carrying leads are joined to the terminal portions; however, it is preferable to fill zirconia mortar in the joining portions of the current-carrying leads.

The present invention is now explained more specifically with reference to some inventive and comparative examples.

### EXAMPLE 1

One hundred (100) parts by weight of yttria-stabilized zirconia powders and 100 parts by weight of yttria-stabilized zirconia fibers having a diameter of 5 μm blended together with 5 parts by weight of methyl cellulose and 70 parts by weight of water were press molded at a pressure of 100 MPa and then fired to prepare a heating element as shown in FIG. 4. This heating element had an outside diameter of 40 mm and an inside diameter of 25 mm while a heating element portion had a length of 20 mm and an outside diameter of 30 mm with a terminal portion length of 40 mm.

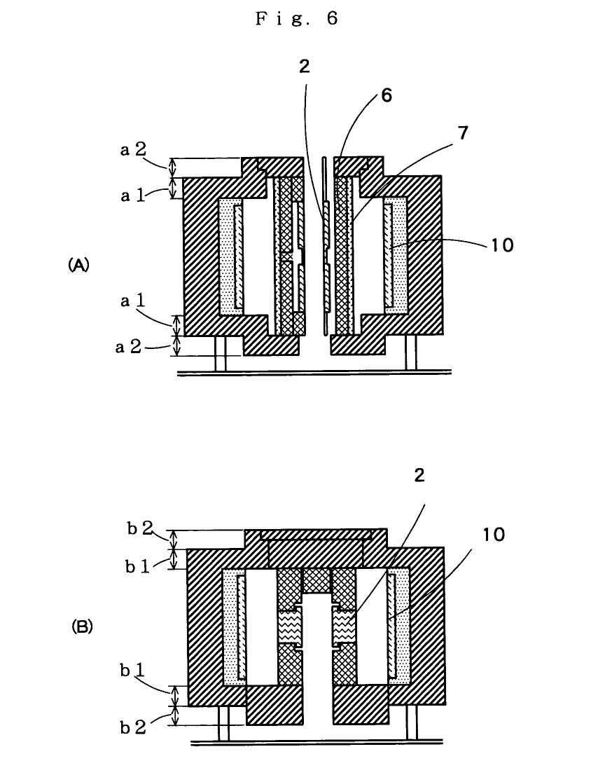

This zirconia-based heating element was used to prepare an electric resistance furnace as shown in FIG. 6(A). In FIG. 6(A), a concentric zirconia-based refractory 6 having a diameter of 85 mm was located at a space of 10 mm from a zirconia-based heating element 2, and a concentric, cylindrical alumina-based refractory 7 having an outside diameter of 100 mm was positioned around the refractory 6.

At a space of 40 mm away from the outside of the alumina-based refractory, there was located a heat-insulating member having a diameter of 240 mm with a preheating element 10 located on the inner surface of a cylindrical member having an inside diameter of 180 mm. Around the heat-insulating member, there was provided a prismatic alumina-silica fiber heat-insulating member having one side length of 325 mm and a thickness of 42 mm. Upper and lower alumina-silica fiber heat-insulating members having a thickness of a1=25 mm were provided, and the uppermost and lowermost heat-insulating members having a thickness of a2=25 mm and formed of the same material as that of the upper and lower heat-insulating members were positioned on the outside of the upper and lower heat-insulating members and on the center axis side with respect to an area of projection of the preheating element, thereby preparing an electric resistance furnace with a preheating furnace provided around the zirconia-based heating element.

Around the furnace arrangement, there was provided a 1.0 mm-thick, soft steel punching metal having a number of openings of 3.0 mm in diameter.

Electric current was passed through the preheating element to allow the temperature of the zirconia-based heating element to reach 1,100° C., and the passage of electric current through the preheating element was thereafter switched over to the passage of electric current through the zirconia-based heating element to heat a heating space in the zirconia-based heating element up to the temperature of 2,000° C. Consequently, the temperature in the preheating furnace was found to reach a maximum of 1,250° C., which was lower than the heat-endurance temperature of the preheating element used.

It was also found that the electric resistance furnace of this example could stably withstand up to 150 cycle tests wherein a sample was heated at a heating rate of 5° C./min, held at 2,000° C. for 1 hour, and cooled at a cooling rate of 5° C./min.

### EXAMPLE 2

One hundred (100) parts by weight of yttria-stabilized zirconia powders and 100 parts by weight of yttria-stabilized zirconia fibers having a diameter of 5 μm blended together with 5 parts by weight of methyl cellulose and 70 parts by weight of water were press molded at a pressure of 100 MPa and then fired to prepare a heating element as shown in FIG. 5(A). In this heating element, a heating element body had an outside diameter of 48 mm, an inside diameter of 40 mm and a length 40 mm with a terminal portion length of 25 mm.

This zirconia-based heating element was used to prepare an electric resistance furnace as shown in FIG. 6(B). In FIG. 6(B), at a space of 40 mm away from the ends of the terminal portions of the zirconia-based heating element, there was located a heat-insulating member having a diameter of 240 mm with a preheating element 10 located on the inner surface of a cylindrical member having an inside diameter of 180 mm. Around the heat-insulating member, there was provided a prismatic alumina-silica fiber heat-insulating member having one side length of 325 mm and a thickness of 42 mm. Upper and lower alumina-silica fiber heat-insulating members having a thickness of b1=25 mm were provided, and the uppermost and lowermost heat-insulating members having a thickness of b2=25 mm and formed of the same material as that of the upper and lower heat-insulating members were positioned on the outside of the upper and lower heat-insulating members and on the center axis side with respect to an area of projection of the preheating element 10, thereby preparing an electric resistance furnace with a preheating furnace provided around the zirconia-based heating element.

Around the furnace arrangement, there was provided a 1.2 mm-thick, soft steel punching metal having a number of openings of 4.0 mm in diameter.

Electric current was passed through the preheating element to allow the temperature of the zirconia-based heating element to reach 1,100° C., and the passage of electric current through the preheating element was thereafter switched over to the passage of electric current through the zirconia-based heating element to heat a heating space in the zirconia-based heating element up to the temperature of 2,000° C. Consequently, the temperature in the preheating furnace was found to reach a maximum of 1,300° C., which was lower than the heat-endurance temperature of the preheating element used.

It was also found that the electric resistance furnace of this example could stably withstand up to 150 cycle tests wherein a sample was heated at a heating rate of 5° C./min, held at 2,000° C. for 1 hour, and cooled at a cooling rate of 5° C./min.

### Comparative Example 1

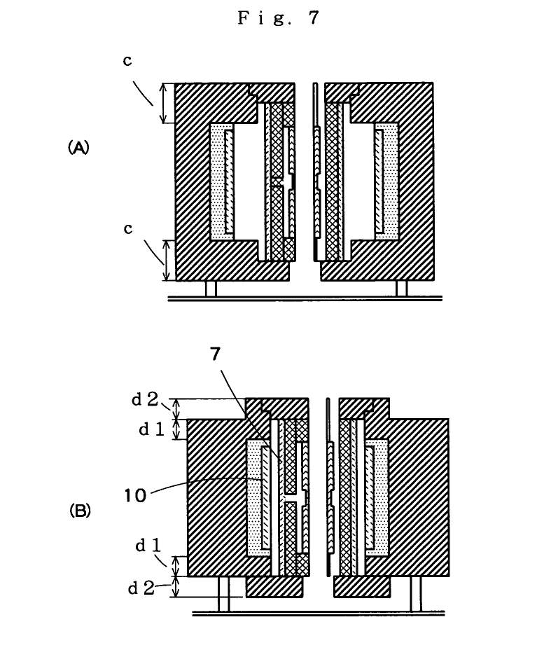

An electric resistance furnace as shown in FIG. 7(A) was prepared following Example 1 with the exception that the upper and lower heat-insulating members had a thickness of 50 mm. Then, this furnace was run with a heating space heated to a temperature of 2,000° C. and the upper and lower heat-insulating members having a thickness of d=50 mm. Consequently, the interior temperature of the preheating furnace was found to reach a maximum of 1,400° C. that was greater than the heat-endurance temperature of the preheating element.

### Comparative Example 2

An electric resistance furnace as shown in FIG. 7(B) was prepared following Example 1 with the exception that between an alumina heat-insulating member 7 and a preheating element 10 around a zirconia-based heating element, there was provided a gap of 10 mm. Further, upper and lower heat-insulating members having a thickness of d1=25 mm were provided, and the uppermost and lowermost heat-insulating members having a thickness of d2=25 mm were positioned on those upper and lower heat-insulating members and at an area of projection of a preheating means. Then, the furnace was run with a heating space heated to a temperature of 2,000° C. Consequently, the interior temperature of the preheating furnace 10 was found to reach a maximum of 1,400° C.

### Comparative Example 3

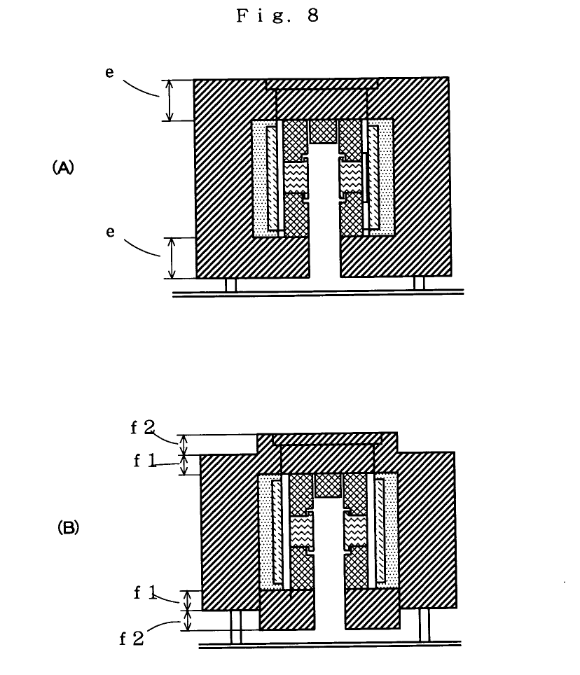

An electric resistance furnace as shown in FIG. 8(A) was prepared following Example 2 with the exception that the upper and lower heat-insulating members had a thickness of e=50 mm, and then run with a heating space heated to a temperature of 2,000° C. Consequently, it was found that the interior temperature of the preheating furnace reached a maximum of 1,500° C.

### Comparative Example 4

An electric resistance furnace as shown in FIG. 8(B) was prepared following Example 1 with the exception that between the outermost periphery of a zirconia-based heating element and a preheating element, there was provided a gap of 10 mm. Further, upper and lower heat-insulating members having a thickness of f1=25 mm were provided, and the uppermost and lowermost heat-insulating members having a thickness of f2=25 mm were positioned on those upper and lower heat-insulating members and at an area of projection of a preheating means. Then, the furnace was run with a heating space heated to a temperature of 2,000° C. Consequently, it was found that the interior temperature of the preheating furnace reached a maximum of 1,450° C.

In the electric resistance furnace of the present invention, the given space is provided between the resistance heating element requiring preheating such as a zirconia-based heating element and a preheating element provided around the resistance heating element, and the thickness of a heat-insulating member positioned inwardly of the area of projection of the innermost portion of the preheating element is larger than the thickness of a heat-insulating member located on an outer portion thereof. This ensures sufficient insulation of heat generated out of the resistance heating element and enables sufficient dissipation of heat from a site where the preheating element is located, so that thermal influences on the preheating element or the like provided around the resistance heating element can be reduced. Thus, the present invention can provide an electric resistance furnace that can be used repetitively over and over.

What we claim is:

1. An electric resistance furnace comprising an axially vertical, hollow center heating element, a center furnace body that comprises a heat-insulating member and is provided for supporting said center heating element, and a preheating means that is provided at a gap from a surface of said center furnace body and comprises a preheating element provided on an inner wall surface of a cylindrical heat-insulating member, wherein:
a heat-insulating member is located at an upper surface and a lower surface of an outer heat-insulating member located around said preheating member and on only a center axis side of said furnace with respect to an area of projection of said preheating means.

2. The electric resistance furnace according to claim 1, wherein said center furnace body comprises a cylindrical, center heating element with electrically conductive connection terminal portions provided at two axial ends and a cylindrical insulator that surrounds said center heating element.

3. The electric resistance furnace according to claim 1, wherein said center furnace body comprises a center heating element wherein electrically conductive connection terminal portions are formed on a wall surface of a cylindrical member in a direction at right angles with an axis thereof, and a holder member provided on an upper portion and a lower portion thereof, an outside diameter of which is given by a maximum diameter of the terminal portions of said center heating element.

4. The electric resistance furnace according to claim 1, wherein said center furnace body is a zirconia-based heating element.

5. The electric resistance furnace according to claim 2, wherein said center furnace body is a zirconia-based heating element.

6. The electric resistance furnace according to claim 3, wherein said center furnace body is a zirconia-based heating element.
